(19) United States
(12) Patent Application Publication
(10) Pub. No.: US 2025/0253774 A1
(43) Pub. Date: Aug. 7, 2025

(54) POWER SUPPLY VOLTAGE CONTROL OF ISOLATED SWITCHING CIRCUIT AND METHOD THEREOF

(71) Applicant: Chengdu Monolithic Power Systems Co., Ltd., Chengdu (CN)

(72) Inventor: Yuzhou Zhang, Hangzhou (CN)

(21) Appl. No.: 19/045,334

(22) Filed: Feb. 4, 2025

(30) Foreign Application Priority Data
Feb. 5, 2024 (CN) 202410167048.5

(51) Int. Cl. H02M 3/335; H02M 1/32; H02M 3/00

(52) U.S. Cl. CPC H02M 3/33571; H02M 1/32; H02M 3/01

(57) ABSTRACT

A power supply control circuit for an isolated switching circuit is provided. The control circuit includes a first voltage output circuit, a second voltage output circuit and a power supply voltage output circuit. The first voltage output circuit provides a first voltage indicating an input voltage of the isolated switching circuit based on a first auxiliary winding voltage from a first auxiliary winding of the isolated switching circuit. The second voltage output circuit provides a second voltage indicating an output voltage of the isolated switching circuit based on a second auxiliary winding voltage from a second auxiliary winding of the isolated switching circuit. The power supply voltage output circuit is coupled to the first voltage output circuit and the second voltage output circuit and provides the power supply voltage based on the first voltage and the second voltage.

### CROSS-REFERENCE TO RELATED APPLICATIONS

This application claims the benefit of and priority to Chinese Application No. 202410167048.5, filed on Feb. 5, 2024, which is incorporated herein by reference into the present application.

### TECHNICAL FIELD

The present disclosure relates generally to electronic circuits, and more particularly but not exclusively to a power supply control circuit used in an isolated switching circuit and associated methods.

### BACKGROUND OF THE INVENTION

For isolated switching power supply, auxiliary windings are often used for providing the power supply voltage to the switching control circuit of the isolated switching power supply. For example, in an asymmetrical half-bridge flyback converter 10 as shown in FIG. 1, a switching control circuit 101 receives the power supply voltage Vcc provided by the auxiliary winding Na. Specifically, the power supply voltage Vcc provided by the auxiliary winding Na is proportional to the output voltage Vout, which is determined by the turns ratio of the auxiliary winding Na to a secondary winding Ns. To ensure the normal operation of the switching control circuit 101, the turns ratio of the auxiliary winding Na to the secondary winding Ns should be greater than a certain value (e.g., Na:Ns>3:1). However, when the range of the output voltage Vout is wide (e.g., 5V-48V), the power supply voltage Vcc provided by the auxiliary winding Na would change in a wide range (e.g., 15V-144V), resulting in high power loss.

### SUMMARY OF THE INVENTION

According to an embodiment of the present disclosure, a power supply control circuit for an isolated switching circuit is provided. The power supply control circuit includes a first voltage output circuit, a second voltage output circuit and a power supply voltage output circuit. The first voltage output circuit receives a first auxiliary winding voltage from a first auxiliary winding of the isolated switching circuit and provides a first voltage indicating an input voltage of the isolated switching circuit based on the first auxiliary winding voltage. The second voltage output circuit receives a second auxiliary winding voltage from a second auxiliary winding of the isolated switching circuit and provides a second voltage indicating an output voltage of the isolated switching circuit based on the second auxiliary winding voltage. The power supply voltage output circuit is coupled to the first voltage output circuit and the second voltage output circuit. The power supply voltage output circuit provides a power supply voltage based on the first voltage and the second voltage.

According to another embodiment of the present disclosure, an isolated switching circuit is provided. The isolated switching circuit includes a transformer, a first primary switch, a second primary switch, a resonant capacitor, a switching control circuit and a power supply control circuit. The transformer has a primary winding, a secondary winding, a first auxiliary winding and a second auxiliary winding. The first primary switch is coupled between an input terminal of the isolated switching circuit and a switching terminal. The second primary switch is coupled between the switching terminal and a primary ground. The resonant capacitor is coupled in series with the primary winding. The switching control circuit controls the first primary switch and the second primary switch. The power supply control circuit provides a power supply voltage to the switching control circuit. The power supply control circuit includes a first voltage output circuit, a second voltage output circuit and a power supply voltage output circuit. The first voltage output circuit receives a first auxiliary winding voltage from the first auxiliary winding and provides a first voltage indicating an input voltage of the isolated switching circuit based on the first auxiliary winding voltage. The second voltage output circuit receives a second auxiliary winding voltage from the second auxiliary winding and provides a second voltage indicating an output voltage of the isolated switching circuit based on the second auxiliary winding voltage. The power supply voltage output circuit is coupled to the first voltage output circuit and the second voltage output circuit. The power supply voltage output circuit provides a power supply voltage based on the first voltage and the second voltage.

According to yet another embodiment of the present disclosure, a method for providing a power supply voltage for an isolated switching circuit is provided. The isolated switching circuit has a primary circuit, a secondary circuit and a transformer. The transformer has a primary winding, a secondary winding, a first auxiliary winding and a second auxiliary winding. The method includes following actions. A first auxiliary winding voltage from the first auxiliary winding is received, and a first voltage indicating an input voltage of the isolated switching circuit based on the first auxiliary winding voltage is provided. A second auxiliary winding voltage from the second auxiliary winding is received, and a second voltage indicating an output voltage of the isolated switching circuit is provided based on the second auxiliary winding voltage. The power supply voltage is provided based on the first voltage and the second voltage.

### BRIEF DESCRIPTION OF THE DRAWINGS

The present disclosure can be further understood with reference to the following detailed description and appended drawings, where like elements are provided with like reference numerals. These drawings are only for illustration purpose, thus may only show part of the devices and are not necessarily drawn to scale.

FIG. 1 schematically shows a conventional asymmetrical half-bridge flyback converter.

FIG. 2 schematically shows an asymmetrical half-bridge flyback converter in accordance with one embodiment of the present disclosure.

FIG. 3 schematically show a power supply control circuit in accordance with one embodiment of the present disclosure.

FIG. 4 schematically shows a power supply control circuit in accordance with another embodiment of the present disclosure.

FIG. 5 schematically shows a power supply control circuit in accordance with yet another embodiment of the present disclosure.

FIG. 6 schematically shows a power supply control circuit in accordance with yet another embodiment of the present disclosure.

FIG. 7 schematically shows a power supply control circuit in accordance with one embodiment of the present disclosure.

FIG. 8 schematically shows a power supply control circuit in accordance with another embodiment of the present disclosure.

FIG. 9 schematically shows a power supply control circuit in accordance with yet another embodiment of the present disclosure.

FIG. 10 shows a flowchart of a method for providing a power supply voltage for an isolated switching circuit in accordance with one embodiment of the present disclosure.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

Throughout the specification and claims, the phrases “in one embodiment” “in some embodiments”, “in one implementation”, and “in some implementations” as used includes both combinations and sub-combinations of various features described herein as well as variations and modifications thereof. These phrases used herein do not necessarily refer to the same embodiment, although it may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element, or indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

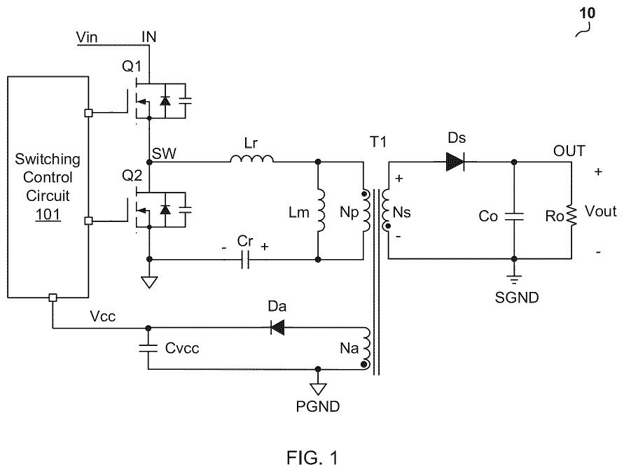

Isolated switching power supplies often use auxiliary windings to power their switching control circuits. As shown in FIG. 1, the conventional asymmetrical half-bridge flyback converter 10 is illustrated as an example. The asymmetrical half-bridge flyback converter 10 includes a primary circuit, a secondary circuit and a transformer. As shown in FIG. 1, the auxiliary winding Na, a primary winding Np and the secondary winding Ns are magnetically coupled to the same core. The auxiliary winding Na provides the power supply voltage Vcc to the switching control circuit 101. The value of the power supply voltage Vcc is determined according to the output voltage Vout. In other words, the power supply voltage Vcc is calculated according to the output voltage Vout and the turns ratio of the secondary winding Ns to the auxiliary winding Na, i.e., Vcc:Vout=Na:Ns. For example, when the turns ratio of the auxiliary winding Na to the secondary winding Ns is 1:1, the power supply voltage Vcc is equal to the output voltage Vout.

The power supply voltage Vcc should be above a lower limit threshold to ensure the normal operation of the switching control circuit 101. For example, when the range of the output voltage Vout of the asymmetrical half-bridge flyback converter 10 is within a range of 5V to 48V and the lower limit threshold is 15V, the turns ratio of the auxiliary winding Na to the secondary winding Ns should be at least 3:1. However, if the turns ratio of the auxiliary winding Na to the secondary winding Ns is 3:1, the power supply voltage Vcc is up to 144V when the output voltage Vout is 48V, which leads to high power loss. In other words, in practical applications, it is difficult to meet the low power loss requirement when the switching control circuit is powered based on the output voltage Vout or an input voltage Vin.

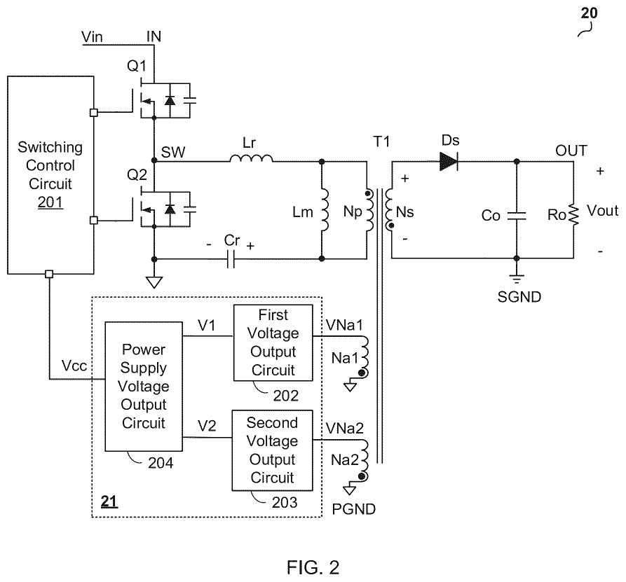

FIG. 2 schematically shows an asymmetrical half-bridge flyback converter 20 in accordance with one embodiment of the present disclosure. The asymmetrical half-bridge flyback converter 20 includes a primary circuit, a secondary circuit and a transformer T1. The primary circuit includes a first primary switch Q1, a second primary switch Q2 and a resonant capacitor Cr. The secondary circuit includes a secondary switch Ds, an output capacitor Co and a load Ro. The transformer T1 has a primary winding Np, a secondary winding Ns, a first auxiliary winding Na1 and a second auxiliary winding Na2. The first primary switch Q1 is coupled between an input terminal IN and a switching terminal SW. The second primary switch Q2 is coupled between the switching terminal SW and a primary ground PGND. The resonant capacitor Cr is coupled in series with the primary winding Np between the switching terminal SW and the primary ground PGND. As shown in FIG. 2, the switching terminal SW is a connection node of the first primary switch Q1 and the second primary switch Q2. The secondary switch Ds is coupled in series with the secondary winding Ns.

As shown in FIG. 2, the input terminal IN is configured to receive the input voltage Vin. In one embodiment, the input voltage Vin is a DC voltage obtained by rectifying an AC voltage. In the embodiment of FIG. 2, the first primary switch Q1 and the second primary switch Q2 are implemented by Metal Oxide Field Effect Transistors (MOSFETs). In other embodiments, the first primary switch Q1 and the second primary switch Q2 may be implemented by other suitable switches, such as Bipolar Junction Transistors (BJTs) and Insulated Gate Bipolar Transistors (IGBTs). As shown in FIG. 2, a resonant inductor Lr represents a leakage inductance of the primary winding Np rather than an actual inductor. In some embodiments, a discrete inductor may be applied as the resonant inductor Lr according to practical applications. As shown in FIG. 2, the secondary switch Ds is a diode. It should be understood that the secondary switch Ds may also be implemented by a controllable switch, e.g. MOSFET. In some embodiments, the secondary switch Ds is coupled between the secondary winding Ns and a secondary ground SGND.

In the embodiment of FIG. 2, the asymmetrical half-bridge flyback converter 20 further includes a switching control circuit 201. The switching control circuit 201 is configured to control the first primary switch Q1 and the second primary switch Q2. By alternately turning on and off the first primary switch Q1 and the second primary switch Q2, the energy is transferred from the primary side to the secondary side, such that the output voltage Vout across the output capacitor Co is generated to power the load Ro. Specifically, when the first primary switch Q1 is on and the second primary switch Q2 is off, the primary winding Np and the resonant capacitor Cr store energy, and the output capacitor Co powers the load Ro. When the first primary switch Q1 is off and the second primary switch Q2 is on, the energy stored in the primary winding Np and the resonant capacitor Cr is transferred to the secondary winding Ns to charge the output capacitor Co and to power the load Ro.

In the embodiment of FIG. 2, the asymmetrical half-bridge flyback converter 20 further includes a power supply control circuit 21 for powering the switching control circuit 201. The power supply control circuit 21 includes a first voltage output circuit 202, a second voltage output circuit 203 and a power supply voltage output circuit 204. The first voltage output circuit 202 is configured to receive a first auxiliary winding voltage VNa1 from the first auxiliary winding Na1, and to provide a first voltage V1 indicating the input voltage Vin based on the first auxiliary winding voltage VNa1. The second voltage output circuit 203 is configured to receive a second auxiliary winding voltage VNa2 from the second auxiliary winding Na2, and to provide a second voltage V2 indicating the output voltage Vout based on the second auxiliary winding voltage VNa2. The power supply voltage output circuit 204 is configured to receive the first voltage V1 and the second voltage V2, and to provide a power supply voltage Vcc based on the first voltage V1 and the second voltage V2, for powering the switching control circuit 201. In other words, the power supply voltage output circuit 204 is configured to provide the power supply voltage Vcc based on the first voltage V1 indicating the input voltage Vin and the second voltage V2 indicating the output voltage Vout.

For instance, in one implementation, the input voltage Vin is within a range of 128V to 374V and the output voltage Vout is within a range of 5V to 48V. In this case, when the output voltage Vout of the asymmetrical half-bridge flyback converter 20 is relatively large (e.g., 48V) and the input voltage Vin is relatively small (e.g., 128V), the power supply voltage output circuit 204 powers the switching control circuit 201 based on the first voltage V1 indicating the input voltage Vin (e.g., 128V). On the other hand, when the output voltage Vout of the asymmetrical half-bridge flyback converter 20 is relatively small (e.g., 5V) and the input voltage Vin is relatively large (e.g., 320V), the power supply voltage output circuit 204 powers the power supply control circuit 201 based on the second voltage V2 indicating the output voltage Vout (e.g., 5V). In one embodiment, the smaller one of the first voltage V1 and the second voltage V2 is provided as the power supply voltage Vcc. That is, when the first voltage V1 is less than the second voltage V2, the power supply voltage Vcc is equal to the first voltage V1. Alternatively, when the first voltage V1 is greater than the second voltage V2, the power supply voltage Vcc is equal to the second voltage V2. Therefore, the range of the power supply voltage Vcc is limited.

In the embodiments of the present disclosure, the working principle of the power supply control circuit is described with reference to the asymmetrical half-bridge flyback converter 20. It should be appreciated that the power supply control circuit of the present disclosure is applicable to other isolated switching circuits, e.g., flyback circuit, forward circuit and LLC circuit.

Based on the above, the power supply control circuit in the embodiments of the present disclosure powers the switching control circuit based on the input voltage and the output voltage of the isolated switching circuit, thereby effectively limiting the range of the power supply voltage. Therefore, the power loss of the isolated switching circuit is reduced, even for a wide input voltage range and/or a wide output voltage range.

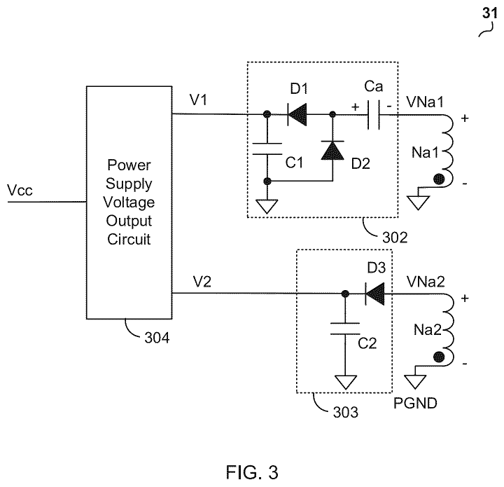

FIG. 3 schematically show a power supply control circuit 31 in accordance with one embodiment of the present disclosure. In the embodiment of FIG. 3, the power supply control circuit 31 includes a first voltage output circuit 302, a second voltage output circuit 303 and a power supply voltage output circuit 304. The first voltage output circuit 302 includes a first auxiliary winding capacitor Ca, a first switch D1, a second switch D2 and a first capacitor C1. The first auxiliary winding capacitor Ca has a first terminal and a second terminal. The first terminal of the first auxiliary winding capacitor Ca is coupled to the first auxiliary winding Na1 of the asymmetrical half-bridge flyback converter 20. The first switch D1 has a first terminal and a second terminal. The first terminal of the first switch D1 is coupled to an output terminal of the first voltage output circuit 302. The second terminal of the first switch D1 is coupled to the second terminal of the first auxiliary winding capacitor Ca. The second switch D2 has a first terminal and a second terminal. The first terminal of the second switch D2 is coupled to the second terminal of the first auxiliary winding capacitor Ca, the second terminal of the second switch D2 is coupled to the primary ground PGND. The first capacitor C1 is coupled between the output terminal of the first voltage output circuit 302 and the primary ground PGND.

The second voltage output circuit 303 includes a third switch D3 and a second capacitor C2. The third switch D3 has a first terminal and a second terminal. The first terminal of the third switch D3 is coupled to an output terminal of the second voltage output circuit 303. The second terminal of the third switch D3 is coupled to the second auxiliary winding Na2 of the asymmetrical half-bridge flyback converter 20. The second capacitor C2 is coupled between the output terminal of the second voltage output circuit 303 and the primary ground PGND.

In the embodiment of FIG. 3, the first switch D1, the second switch D2 and the third switch D3 are diodes. In other embodiments, the first switch D1, the second switch D2 and the third switch D3 may be other suitable switching elements, e.g., MOSFETS.

When the first primary switch Q1 is on and the second primary switch Q2 is off, the first auxiliary winding capacitor Ca, the first auxiliary winding Na1 and the second switch D2 form an energy storage loop. The current flows from the first auxiliary winding Na1 through the primary ground PGND and the second switch D2 to the first auxiliary winding capacitor Ca, to charge the first auxiliary winding capacitor Ca. The voltage VCa across the first auxiliary winding capacitor Ca is equal to the voltage VNa1 across the first auxiliary winding Na1 induced by the primary voltage VNp across the primary winding Np, i.e., VCa=−VNa1. In the embodiment as shown in FIG. 3, the voltage of the undotted terminal of the first auxiliary winding Na1 is lower than the voltage of the dotted terminal of the first auxiliary winding Na1, so the voltage VNa1 of the first auxiliary winding Na1 could be expressed as: VNa1=−VNp/(Np/Na1). Therefore, the voltage VCa across the first auxiliary winding capacitor Ca could be expressed as: VCa=−VNa1=VNp/(Np/Na1). The voltage VNp across the primary winding Np is expressed as: VNp=Vin−VCr, where VCr is the voltage across the resonant capacitor Cr, which is approximately expressed as: VCr=Vout/(Ns/Np). Therefore, the voltage VCa across the first auxiliary winding capacitor Ca could be expressed as: VCa=[Vin−Vout/(Ns/Np)]/(Np/Na1).

When the first primary switch Q1 is off and the second primary switch Q2 is on, the first auxiliary winding Na1, the first auxiliary winding capacitor Ca, the first switch D1 and the first capacitor C1 form another energy storage loop. The current flows from the first auxiliary winding Na1 through the first auxiliary winding capacitor Ca and the first switch D1 to the first capacitor C1, to charge the first capacitor C1. The charging voltage VC1 across the first capacitor C1 is equal to the sum of the voltage VCa across the first auxiliary winding capacitor Ca and the voltage VNa1 of the first auxiliary winding Na1 induced by the output voltage Vout, so the charging voltage VC1 could be expressed as VC1=VCa+VNa1=[Vin−Vout/(Ns/Np)]/(Np/Na1)+Vout/(Ns/Na1)=Vin/(Np/Na1). The first voltage V1 provided by the first voltage output circuit 302 is equal to the charging voltage VC1 across the first capacitor C1. Therefore, the first voltage V1 provided by the first voltage output circuit 302 could be expressed as: V1=VC1=Vin/(Np/Na1).

Similarly, when the first primary switch Q1 is off and the second primary switch Q2 is on, the second auxiliary winding Na2, the third switch D3 and the second capacitor C2 form an energy storage loop. The current flows from the second auxiliary winding Na2 through the third switch D3 to the second capacitor C2, to charge the second capacitor C2. In this case, the voltage VNa2 of the second auxiliary winding Na2 is induced by the output voltage Vout, i.e., VNa2=Vout/(Ns/Na2). Therefore, the second voltage V2 provided by the second voltage output circuit 303 could be expressed as: V2=VNa2=Vout/(Ns/Na2).

As illustrated above, the first voltage V1 provided by the first voltage output circuit 302 indicates the input voltage Vin, and the second voltage V2 provided by the second voltage output circuit 303 indicates the output voltage Vout. It should be appreciated that, since the non-ideal characteristics of the components of the circuits (e.g., the switches D1-D3 have voltage drops during its on-state), the first voltage V1 obtained by the equation V1=Vin/(Np/Na1) and the second voltage V2 obtained by the equation V2=Vout/(Ns/Na2) are approximations.

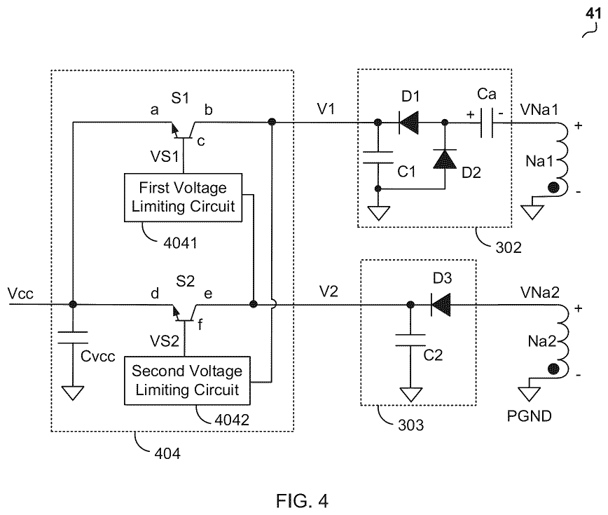

FIG. 4 schematically shows a power supply control circuit 41 in accordance with another embodiment of the present disclosure. In the embodiment of FIG. 4, the power supply voltage output circuit 404 includes a power supply capacitor Cvcc, a first controllable switch S1, a second controllable switch S2, a first voltage limiting circuit 4041 and a second voltage limiting circuit 4042. The power supply capacitor Cvcc has a first terminal coupled to an output terminal of the power supply voltage output circuit 404 and a second terminal coupled to the primary ground PGND. The first controllable switch S1 includes a first terminal a, a second terminal b and a control terminal c. The first terminal a of the first controllable switch S1 is coupled to the first terminal of the power supply capacitor Cvcc. The second terminal b of the first controllable switch S1 is coupled to the first voltage output circuit 302 to receive the first voltage V1. The first voltage limiting circuit 4041 is configured to receive the second voltage V2, and to provide a first control voltage VS1 to the control terminal c of the first controllable switch S1 based on the second voltage V2. The second controllable switch S2 includes a first terminal d, a second terminal e and a control terminal f. The first terminal d of the second controllable switch S2 is coupled to the first terminal of the power supply capacitor Cvcc. The second terminal f of the second controllable switch S2 is coupled to the second voltage output circuit 303 to receive the second voltage V2. The second voltage limiting circuit 4042 is configured to receive the first voltage V1, and to provide a second control voltage VS2 to the control terminal f of the second controllable switch S2 based on the first voltage V1.

In the embodiment of FIG. 4, the first controllable switch S1 is a BJT, having the first terminal a (e.g., emitter), the second terminal b (e.g., collector) and the control terminal c (e.g., base). The second controllable switch S2 is a BJT, having the first terminal d (e.g., emitter), the second terminal e (e.g., collector) and the control terminal f (e.g., base). In other embodiments, the first controllable switch S1 and the second controllable switch S2 could be implemented by other suitable controllable switches, e.g., MOSFETs. In one embodiment, the first controllable switch S1 is a MOSFET, having the first terminal a (e.g., source), the second terminal b (e.g., drain) and the control terminal c (e.g., gate). In one embodiment, the second controllable switch S2 is a MOSFET, having the first terminal d (e.g., source), the second terminal e (e.g., drain) and the control terminal f (e.g., gate).

In some embodiments, when the first voltage V1 is greater than a first limiting voltage VL1, the second control voltage VS2 provided by the second voltage limiting circuit 4042 is equal to the first limiting voltage VL1. In some other embodiments, when the first voltage V1 is less than the first limiting voltage VL1, the second control voltage VS2 provided by the second voltage limiting circuit 4042 is equal to the first voltage V1. Therefore, the voltage Vf of the control terminal f of the second controllable switch S2 could be expressed as: Vf=VS2=MIN(V1, VL1).

In some embodiments, when the second voltage V2 is greater than a second limiting voltage VL2, the first control voltage VS1 provided by the first voltage limiting circuit 4041 is equal to the second limiting voltage VL2. In some other embodiments, when the second voltage V2 is less than the second limiting voltage VL2, the first control voltage VS1 provided by the first voltage limiting circuit 4041 is equal to the second voltage V2. Therefore, the voltage Vc of the control terminal c of the first controllable switch S1 could be expressed as: Vc=VS1=MIN(V2, VL2). In one embodiment, the first limiting voltage VL1 is less than the second limiting voltage VL2.

In some embodiments, the first voltage limiting circuit 4041 or the second voltage limiting circuit 4042 may include a comparator configured to compare the received voltage with the corresponding limiting voltage. The comparator is configured to provide the received voltage when the received voltage is less than the corresponding limiting voltage, and to provide the corresponding limiting voltage when the received voltage is greater than the corresponding limiting voltage. Thus, the output voltage of the comparator is limited within a certain range. Persons having ordinary skill in the art should be understood that other circuits having the aforementioned voltage limiting function could be used as the voltage limiting circuit in the present disclosure.

In the embodiment of FIG. 4, when the voltage Vc of the control terminal c of the first controllable switch S1 is greater than the voltage Vb of the second terminal b of the first controllable switch S1, the voltage Vb is provided to the first terminal a of the first controllable switch S1 (e.g., Va=Vb). In other words, when the voltage Vc is greater than the voltage Vb, the first controllable switch S1 operates in saturation region. When the voltage Vc of the control terminal c of the first controllable switch S1 is less than the voltage Vb of the second terminal b of the controllable switch S1, the voltage Vc is provided to the first terminal a of the first controllable switch S1. In one embodiment, the voltage Va could be expressed as: Va=Vc−Vth1, where Vth1 is the threshold voltage of the first controllable switch S1. In other words, when the voltage Vc is less than the voltage Vb, the first controllable switch S1 operates in active region. As illustrated before, the second terminal b of the first controllable switch S1 is configured to receive the first voltage V1 and the control terminal c of the first controllable switch S1 is configured to receive the first control voltage VS1. Therefore, the voltage Va of the first terminal a of the first controllable switch S1 is equal to the smaller one of the first voltage V1 and the first control voltage VS1, which could be expressed as: Va=MIN(V1, VS1)=MIN(V1, MIN(V2, VL2)).

Similarly, when the voltage Vf of the control terminal f of the second controllable switch S2 is greater than the voltage Ve of the second terminal e of the second controllable switch S2, the voltage Ve is provided to the first terminal d of the second controllable switch S2 (e.g., Vd=Ve). In other words, when the voltage Vf is greater than the voltage Ve, the second controllable switch S2 operates in saturation region. When the voltage Vf of the control terminal f of the second controllable switch S2 is less than the voltage Ve of the second terminal e of the second controllable switch S2, the voltage Vf is provided to the first terminal d of the second controllable switch S2. In one embodiment, the voltage Vd could be expressed as: Vd=Vf−Vth2, where Vth2 is the threshold voltage of the second controllable switch S2. In other words, when the voltage Vf is less than the voltage Ve, the second controllable switch S2 operates in active region. As illustrated before, the second terminal e of the second controllable switch S2 is configured to receive the second voltage V2 and the control terminal f of the second controllable switch S2 is configured to receive the second control voltage VS2. Therefore, the voltage Vd of the first terminal d of the second controllable switch S2 is equal to the smaller one of the second voltage V2 and the second control voltage VS2, which could be expressed as: Vd=MIN(V2, VS2)=MIN(V2, MIN(V1, VL1)).

The power supply capacitor Cvcc is configured to provide the power supply voltage Vcc based on the smaller one of the first voltage V1 and the first control voltage VS1 and the smaller one of the second voltage V2 and the second control voltage VS2. In one embodiment, the power supply voltage Vcc could be expressed as: Vcc=MAX(MIN(V1, VS1), MIN(V2, VS2))=MAX(MIN(V1, MIN(V2, VL2)), MIN(V2, MIN(V1, VL1)))

The operating of the power supply control circuit 41 is described below by using several embodiments for ease of understanding.

In some embodiments, the turns ratio of the primary winding Np, the secondary winding Ns, the first auxiliary winding Na1 and the second auxiliary winding Na2 is set to Np:Ns:Na1:Na2=16:4:1:10. The first controllable switch S1 and the second controllable switch S2 are NPN-type BJTs with the same electrical characteristics (e.g., Vth1=Vth2). The first limiting voltage VL1 of the second voltage limiting circuit 4042 is set to 15V and the second limiting voltage VL2 of the first voltage limiting circuit 4041 is set to 16V. The input voltage Vin is within the range of 128V to 374V and the output voltage Vout is within the range of 5V to 48V.

In one embodiment, the input voltage Vin is relatively small (e.g., 128V) and the output voltage Vout is also relatively small (e.g., 5V). The first voltage V1 is 8V (i.e., V1=Vin/(Np/Na1)=8V), and the second voltage V2 is 12.5V (i.e., V2=Vout/(Ns/Na2)=12.5V). In this case, the voltage Vc of the control terminal c of the first controllable switch S1 is 12.5V (i.e., Vc=MIN(V2, VL2)=V2=12.5V), and the voltage Vb of the second terminal b of the first controllable switch S1 is 8V (i.e., Vb=V1=8V), so the voltage Va of the first terminal a of the first controllable switch S1 is 8V (i.e., Va=V1=8V). Meanwhile, the voltage Vf of the control terminal f of the second controllable switch S2 is 8V (i.e., Vf=MIN(V1, VL1)=V1=8V), and the voltage Ve of the second terminal e of the second controllable switch is 12.5V (i.e., Ve=V2=12.5V), so the voltage Vd of the first terminal d of the second controllable switch S2 is V1−Vth2 (i.e., Vd=Vf−Vth2=V1−Vth2=8V−Vth2). Therefore, the power supply voltage Vcc provided by the power supply voltage output circuit 404 is 8V (i.e., Vcc=Va=V1=8V.) In other words, in this case, the power supply voltage output circuit 404 powers the switching control circuit 201 based on the first voltage V1 indicating the input voltage Vin.

In one embodiment, the input voltage Vin is relatively large (e.g., 320V) and the output voltage Vout is relatively small (e.g., 5V). The first voltage V1 is 20V (i.e., V1=Vin/(Np/Na1=20V), and the second voltage V2 is 12.5V (i.e., V2=Vout/(Ns/Na2)=12.5V). In this case, the voltage Vc of the control terminal c of the first controllable switch S1 is 12.5V (i.e., Vc=MIN(V2, VL2)=V2=12.5V), and the voltage Vb of the second terminal b of the first controllable switch S1 is 20V (i.e., Vb=V1=20V), so the voltage Va of the first terminal a of the first controllable switch S1 is V2−Vth1 (i.e., Va=Vc−Vth1=V2−Vth1=12.5V−Vth1). Meanwhile, the voltage Vf of the control terminal f of the second controllable switch S2 is 15V (i.e., Vf=MIN(V1, VL1)=VL1=15V), and the voltage Ve of the second terminal e of the second controllable switch is 12.5V (i.e., Ve=V2=12.5V), so the voltage Vd of the first terminal d of the second controllable switch S2 is 12.5V (i.e., Vd=Ve=V2=12.5V). Therefore, the power supply voltage Vcc provided by the power supply voltage output circuit 404 is 12.5V (i.e., Vcc=Vd=V2=12.5V). In other words, in this case, the power supply voltage output circuit 404 powers the switching control circuit 201 based on the second voltage V2 indicating the output voltage Vout.

In one embodiment, the input voltage Vin is relatively small (e.g., 128V) and the output voltage Vout is relatively large (e.g., 48V). The first voltage V1 is 8V (i.e., V1=Vin/(Np/Na1=8V), and the second voltage V2 is 120V (i.e., V2=Vout/(Ns/Na2)=120V). In this case, the voltage Vc of the control terminal c of the first controllable switch S1 is 16V (i.e., Vc=MIN(V2, VL2)=VL2=16V), and the voltage Vb of the second terminal b of the first controllable switch S1 is 8V (i.e., Vb=V1=8V), so the voltage Va of the first terminal a of the first controllable switch S1 is equal to 8V (Va=V1=8V). Meanwhile, the voltage Vf of the control terminal f of the second controllable switch S2 is 8V (i.e., Vf=MIN(V1, VL1)=V1=8V), and the voltage Ve of the second terminal e of the second controllable switch is 120V (i.e., Ve=V2=120V), so the voltage Vd of the first terminal d of the second controllable switch S2 is V1−Vth2 (i.e., Vd=Vf−Vth2=V1−Vth2=8V−Vth2). Therefore, the power supply voltage Vcc provided by the power supply voltage output circuit 404 is 8V (i.e., Vcc=Va=V1=8V). In other words, in this case, the power supply voltage output circuit 404 powers the switching control circuit 201 based on the first voltage V1 indicating the input voltage Vin.

In one embodiment, the input voltage Vin is relatively large (e.g., 320V) and the output voltage Vout is relatively large (e.g., 48V). The first voltage V1 is 20V (i.e., V1=Vin/(Np/Na1=20V), and the second voltage V2 is 120V (i.e., V2=Vout/(Ns/Na2)=120V). In this case, the voltage Vc of the control terminal c of the first controllable switch S1 is 16V (i.e., Vc=MIN(V2, VL2)=VL2=16V), and the voltage Vb of the second terminal b of the first controllable switch S1 is 20V (i.e., Vb=V1=20V), so the voltage Va of the first terminal a of the first controllable switch S1 is VL2−Vth1 (i.e., Va=Vc−Vth1=VL2−Vth1). Meanwhile, the voltage Vf of the control terminal f of the second controllable switch S2 is 15V (i.e., Vf=MIN(V1, VL1)=VL1=15V), and the voltage Ve of the second terminal e of the second controllable switch is 120V (i.e., Ve=V2=120V), so the voltage Vd of the first terminal d of the second controllable switch S2 is VL1−Vth2 (i.e., Vd=Vf−Vth2=VL1−Vth2). Since the first limiting voltage VL1 is less than the second limiting voltage VL2, the power supply voltage Vcc provided by the power supply capacitor Cvcc is the second limiting voltage VL2 (i.e., Vcc=Va=VL2=16V). In other words, when the input voltage Vin and the output voltage Vout are both relatively large, the power supply voltage output circuit 404 powers the power supply control circuit 201 based on the second limiting voltage VL2, i.e., the power supply voltage Vcc is limited to the second limiting voltage VL2.

As a result, in the power supply voltage output circuit 404, the first controllable switch S1 and the second controllable switch S2 are controlled based on the first voltage V1 and the second voltage V2, so that the power supply voltage Vcc with a small range could be provided. Furthermore, when the input voltage Vin and the output voltage Vout are both relatively large, the voltage limiting circuits 4041 and 4042 could limit the power supply voltage Vcc within a certain voltage range (e.g., the power supply voltage Vcc is limited to the second limiting voltage VL2). Therefore, the power supply control circuit in the embodiments of the present disclosure is capable of providing the power supply voltage Vcc with the small range when the isolated switching circuit has the wide input voltage range and/or the wide output voltage range, thereby reducing the power loss of the isolated switching circuit.

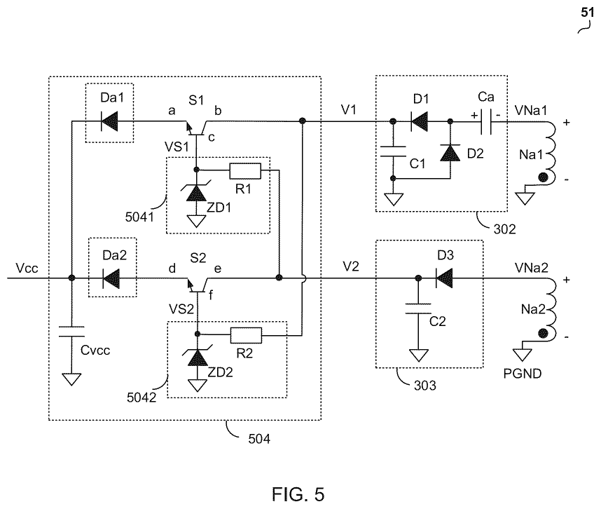

FIG. 5 schematically shows a power supply control circuit 51 in accordance with yet another embodiment of the present disclosure. In the embodiment of FIG. 5, a first voltage limiting circuit 5041 includes a first zener diode ZD1 and a first protection resistor R1. The cathode of the first zener diode ZD1 is coupled to the control terminal c of the first controllable switch S1, the anode of the first zener diode ZD1 is coupled to the primary ground PGND. In one embodiment, the second limiting voltage VL2 is equal to the zener voltage Vzd1 of the first zener diode ZD1. The first protection resistor R1 is used for protecting the first zener diode ZD1. The first protection resistor R1 has a first terminal and a second terminal. The first terminal of the first protection resistor R1 is coupled to the control terminal c of the first controllable switch S1 and the second terminal of the first protection resistor R1 is coupled to the output terminal of the second voltage output circuit 303 to receive the second voltage V2.

The second voltage limiting circuit 5042 includes a second zener diode ZD2 and a second protection resistor R2. The cathode of the second zener diode ZD2 is coupled to the control terminal f of the second controllable switch S2, the anode of the second zener diode ZD2 is coupled to the primary ground PGND. In one embodiment, the first limiting voltage VL1 is equal to the zener voltage Vzd2 of the second zener diode ZD2. On the basis of ensuring that the zener voltage Vzd1 is greater than the zener voltage Vzd2, the zener voltage Vzd1 of the first zener diode ZD1 and the zener voltage Vzd2 of the second zener diode ZD2 may be set according to the actual application requirements. The second protection resistor R2 is used for protecting the second zener diode ZD2. The second protection resistor R2 has a first terminal and a second terminal. The first terminal of the second protection resistor R2 is coupled to the control terminal f of the second controllable switch S2 and the second terminal of the second protection resistor R2 is coupled to the output terminal of the first voltage output circuit 302 to receive the first voltage V1.

In the embodiment of FIG. 5, the power supply voltage output circuit 504 further includes a first output diode Da1 and a second output diode Da2. The first output diode Da1 is used for preventing a current from flowing from the first terminal of the charging capacitor Cvcc to the first controllable switch S1. The second output diode Da2 is used for preventing a current from flowing from the first terminal of the charging capacitor Cvcc to the second controllable switch S2. The first output diode Da1 has a first terminal (e.g., cathode) and a second terminal (e.g., anode). The first terminal of the first output diode Da1 is coupled to the first terminal of the power supply capacitor Cvcc and the second terminal of the first output diode Da1 is coupled to the first terminal a of the first controllable switch S1. The second output diode Da2 has a first terminal (e.g., cathode) and a second terminal (e.g., anode). The first terminal of the second output diode Da2 is coupled to the first terminal of the power supply capacitor Cvcc and the second terminal of the second output diode Da2 is coupled to the first terminal d of the second controllable switch S2.

It should be understood that the first output diode Da1 and the second output diode Da2 are unnecessary components. In other words, the power supply voltage output circuit 504 may not include the first output diode Da1 and the second output diode Da2. In one embodiment, the power supply voltage output circuit 504 includes the second output diode Da2.

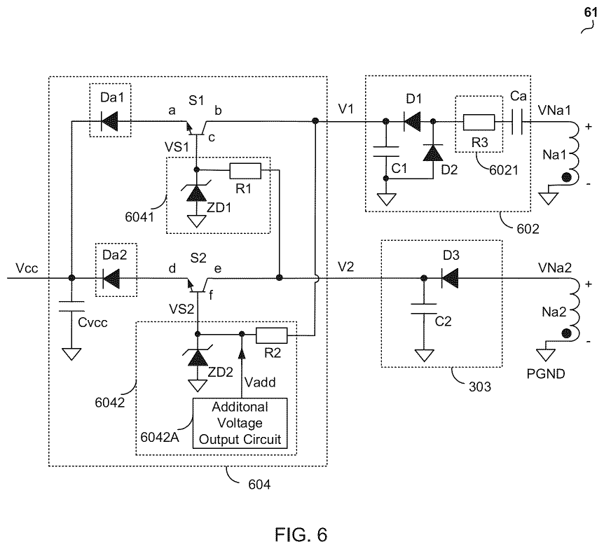

FIG. 6 schematically shows a power supply control circuit 61 in accordance with yet another embodiment of the present disclosure. Compared with FIG. 5, a first voltage output circuit 602 of FIG. 6 further includes a current limiting circuit 6021 and an additional voltage output circuit 6042A. The current limiting circuit 6021 is coupled in series with the first auxiliary winding capacitor Ca. In the embodiment shown in FIG. 6, the current limiting circuit 6021 includes a resistor R3. In other embodiments, the current limiting circuit 6021 includes an inductor.

The additional voltage output circuit 6042A is coupled to the control terminal f of the second controllable switch S2. The additional voltage output circuit 6042A is configured to provide an additional voltage Vadd to ensure the normal operation of the switching control circuit 201. In one embodiment, the additional voltage Vadd is less than the first limiting voltage VL1 and the second limiting voltage VL2. As mentioned before, —the power supply voltage Vcc should be greater than a lower limit threshold to ensure the normal operation of the switching control circuit 201. In some embodiments, the power supply voltage Vcc is equal to the first voltage V1 (i.e., the first voltage V1 is the smallest one between the first voltage V1, the second voltage V2, the first limiting voltage VL1 and the second limiting voltage VL2). When the first voltage V1 is less than the lower limit threshold, the additional voltage output circuit 6042A provides the additional voltage Vadd, so the power supply voltage Vcc could be increased to the lower limit threshold to ensure the normal operation of the switching control circuit 201.

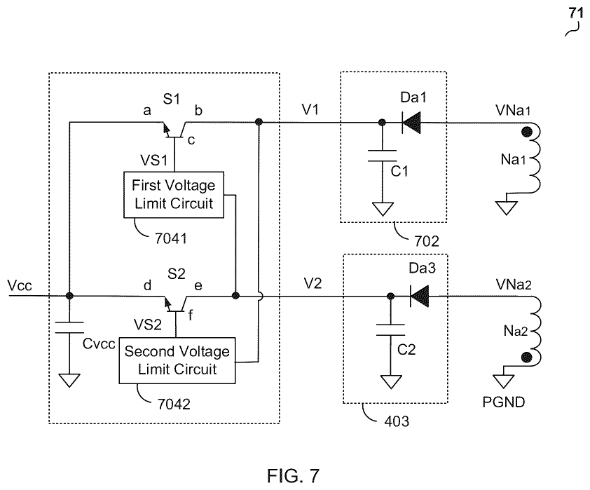

FIG. 7 schematically shows a power supply control circuit 71 in accordance with one embodiment of the present disclosure. Compared with FIG. 4, a first voltage output circuit 702 of FIG. 7 includes a first switch D1 and a first capacitor C1. The first switch D1 has a first terminal and a second terminal. The first terminal of the first switch D1 is coupled to an output terminal of the first voltage output circuit 702, and the second terminal of the first switch D1 is coupled to the first auxiliary winding Na1 of asymmetrical half-bridge flyback converter 20. The first capacitor C1 is coupled between the output terminal of the first voltage output circuit 702 and the primary ground PGND. In this case, the charging voltage VC1 across the first capacitor C1 is equal to the voltage VNa1 of the first auxiliary winding Na1, i.e., VC1=VNa1. The voltage VNa1 of the first auxiliary winding Na1 is induced by the voltage VNp of the primary winding Np, so the first voltage V1 could be expressed as: V1=VC1=VNa1=VNp/(Np/Na1)=(Vin−VCr)/(Np/Na1). That is, the first voltage output circuit 702 provides the first voltage V1 indicating the input voltage Vin. Except that the value of the first voltage V1 provided by the first voltage output circuit 702 is different from the value of the first voltage V1 provided by the first voltage output circuit 302, the operating principle of the power supply control circuit 71 is the same as the power supply control circuit 41 and will not be repeated here.

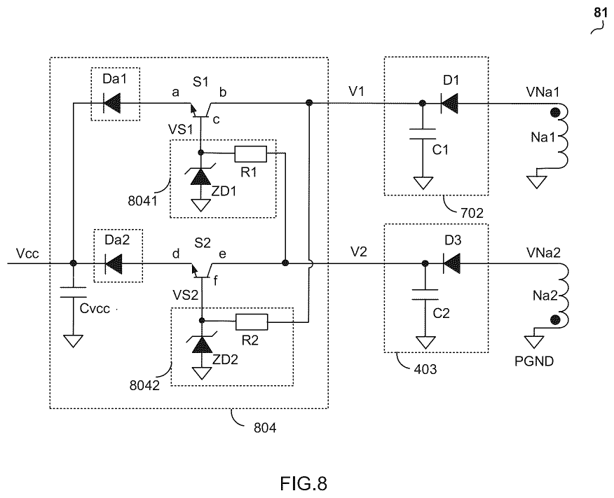

FIG. 8 schematically shows a power supply control circuit 81 in accordance with another embodiment of the present disclosure. Compared with FIG. 7, in the embodiment as shown in FIG. 8, a first voltage limiting circuit 8041 includes the first zener diode ZD1 and the first protection resistor R1. The cathode of the first zener diode ZD1 is coupled to the control terminal c of the first controllable switch S1, the anode of the first zener diode ZD1 is coupled to the primary ground PGND. In one embodiment, the second limiting voltage VL2 of the first voltage limiting circuit 8041 is equal to the zener voltage Vzd1 of the first zener diode ZD1. The first protection resistor R1 is used for protecting the first zener diode ZD1. The first terminal of the first protection resistor R1 is coupled to the control terminal c of the first controllable switch S1 and the second terminal of the first protection resistor R1 is coupled to the output terminal of the second voltage output circuit 403 to receive the second voltage V2.

The second voltage limiting circuit 8042 includes the second zener diode ZD2 and the second protection resistor R2. The cathode of the second zener diode ZD2 is coupled to the control terminal f of the second controllable switch S2, the anode of the second zener diode ZD2 is coupled to the primary ground PGND. In one embodiment, the first limiting voltage VL1 of the second voltage limiting circuit 8042 is equal to the zener voltage Vzd2 of the second zener diode ZD2. On the basis of ensuring that the zener voltage Vzd1 is greater than the zener voltage Vzd2, the zener voltage Vzd1 of the first zener diode ZD1 and the zener voltage Vzd2 of the second zener diode ZD2 may be set according to the actual application requirements. The second protection resistor R2 is used for protecting the second zener diode ZD2. The first terminal of the second protection resistor R2 is coupled to the control terminal f of the second controllable switch S2 and the second terminal of the second protection resistor R2 is coupled to the output terminal of the first voltage output circuit 702 to receive the first voltage V1.

In the embodiment of FIG. 8, the power supply voltage output circuit 804 further includes the first output diode Da1 and the second output diode Da2. The first output diode Da1 is used for preventing the current from flowing from the first terminal of the charging capacitor Cvcc to the first controllable switch S1. The second output diode Da2 is used for preventing the current from flowing from the first terminal of the charging capacitor Cvcc to the second controllable switch S2. The first output diode Da1 has the first terminal (e.g., cathode) and the second terminal (e.g., anode). The first terminal of the first output diode Da1 is coupled to the first terminal of the power supply capacitor Cvcc and the second terminal of the first output diode Da1 is coupled to the first terminal a of the first controllable switch S1. The second output diode Da2 has the first terminal (e.g., cathode) and the second terminal (e.g., anode). The first terminal of the second output diode Da2 is coupled to the first terminal of the power supply capacitor Cvcc and the second terminal of the second output diode Da2 is coupled to the first terminal d of the second controllable switch S2.

It should be understood that the first output diode Da1 and the second output diode Da2 are unnecessary components. In other words, the power supply voltage output circuit 804 may not include the first output diode Da1 and the second output diode Da2. In one embodiment, the power supply voltage output circuit 804 includes the second output diode Da2.

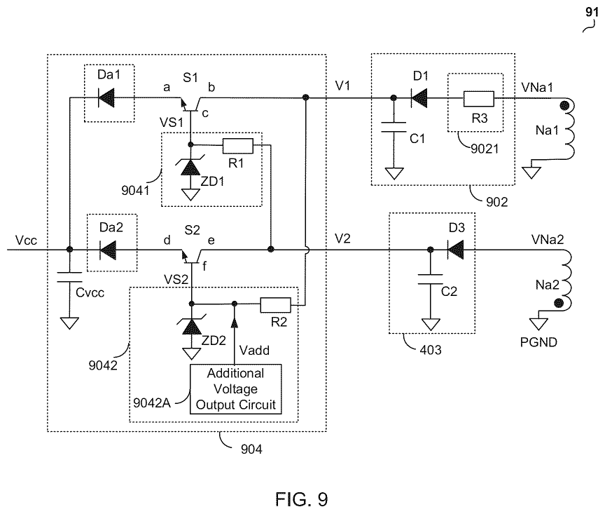

FIG. 9 schematically shows a power supply control circuit in accordance with yet another embodiment of the present disclosure. Compared with FIG. 8, the first voltage output circuit 902 of FIG. 9 further includes a current limiting circuit 9021 and an additional voltage output circuit 9042A. The current limiting circuit 9021 is coupled in series with the first switch D1. In the embodiment shown in FIG. 9, the current limiting circuit 9021 includes the resistor R3. In other embodiments, the current limiting circuit 9021 includes an inductor. The additional voltage output circuit 9042A is coupled to the control terminal f of the second controllable switch S2. The function of the additional voltage output circuit 9042A is the same as the additional voltage output circuit 6042A and will not be repeated here.

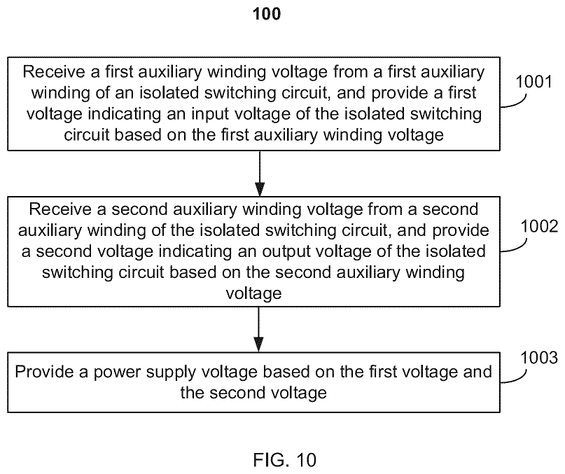

FIG. 10 shows a flowchart of a method for providing a power supply voltage for an isolated switching circuit in accordance with one embodiment of the present disclosure. The isolated switching circuit includes an isolated device (e.g., a transformer), a primary circuit, and a secondary circuit. The primary circuit includes at least one switch. The switch(es) of the primary circuit is turned on and off alternately to transfer the energy from the primary circuit to the secondary circuit for powering a load. In other words, an input voltage received by the primary circuit is transferred to an output voltage to meet the load requirement. The isolated device includes a primary winding, a secondary winding, a first auxiliary winding and a second auxiliary winding. The method includes actions 1001-1003.

In action 1001, a first auxiliary winding voltage from the first auxiliary winding of the isolated switching circuit is received, and a first voltage indicating the input voltage of the isolated switching circuit is provided based on the first auxiliary winding voltage.

In action 1002, a second auxiliary winding voltage from the second auxiliary winding of the isolated switching circuit is received, and a second voltage indicating the output voltage of the isolated switching circuit is provided based on the second auxiliary winding voltage.

In action 1003, a power supply voltage is provided based on the first voltage and the second voltage.

In some embodiments, the action 1003 includes the following actions. The second voltage is received, and a first control voltage is provided based on the second voltage. The first voltage is received, and a second control voltage is provided based on the first voltage. The power supply voltage is provided based on the first voltage, the first control voltage, the second voltage and the second control voltage. In one embodiment, the power supply voltage is provided based on the smaller one of the first voltage and the first control voltage and the smaller one of the second voltage and the second control voltage. When the first voltage is greater than a first limiting voltage, the second control voltage is equal to the first limiting voltage. When the first voltage is less than the first limiting voltage, the second control voltage is equal to the first voltage. When the second voltage is greater than a second limiting voltage, the first control voltage is equal to the second limiting voltage. When the second voltage is less than the second limiting voltage, the first control voltage is equal to the second voltage. The first limiting voltage is less than the second limiting voltage.

It is noted that in the flow charts described above, the functions labelled in the boxes shown in FIG. 10 can also occur in a different sequence. For example, two consecutive blocks, in fact, can be executed substantially concurrently, or they may sometimes be executed in the reverse order, depending upon the particular function involved.

In the present invention, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. A power supply control circuit for an isolated switching circuit, comprising:
a first voltage output circuit configured to receive a first auxiliary winding voltage from a first auxiliary winding of the isolated switching circuit, and to provide a first voltage indicating an input voltage of the isolated switching circuit based on the first auxiliary winding voltage;
a second voltage output circuit configured to receive a second auxiliary winding voltage from a second auxiliary winding of the isolated switching circuit, and to provide a second voltage indicating an output voltage of the isolated switching circuit based on the second auxiliary winding voltage; and
a power supply voltage output circuit coupled to the first voltage output circuit and the second voltage output circuit, wherein the power supply voltage output circuit is configured to provide a power supply voltage based on the first voltage and the second voltage.

2. The power supply control circuit of claim 1, wherein the first voltage output circuit comprises:
a first auxiliary winding capacitor having a first terminal and a second terminal, wherein the first terminal of the first auxiliary winding capacitor is coupled to the first auxiliary winding of the isolated switching circuit;
a first switch coupled between the second terminal of the first auxiliary winding capacitor and an output terminal of the first voltage output circuit;
a second switch coupled between a primary ground and the second terminal of the first auxiliary winding capacitor; and
a first capacitor coupled between the output terminal of the first voltage output circuit and the primary ground.

3. The power supply control circuit of claim 2, wherein the first voltage output circuit further comprises:
a current limiting circuit coupled in series with the first auxiliary winding capacitor.

4. The power supply control circuit of claim 1, wherein the first voltage output circuit comprises:
a first switch coupled between the first auxiliary winding of the isolated switching circuit and an output terminal of the first voltage output circuit; and
a first capacitor coupled between the output terminal of the first voltage output circuit and a primary ground.

5. The power supply control circuit of claim 4, wherein the first voltage output circuit further comprises:
a current limiting circuit coupled in series with the first switch.

6. The power supply control circuit of claim 1, wherein the second voltage output circuit comprises:
a third switch coupled between the second auxiliary winding of the isolated switching circuit and an output terminal of the second voltage output circuit; and
a second capacitor coupled between the output terminal of the second voltage output circuit and a primary ground.

7. The power supply control circuit of claim 1, wherein the power supply voltage output circuit comprises:
a power supply capacitor coupled between an output terminal of the power supply voltage output circuit and a primary ground;
a first controllable switch having a first terminal, a second terminal and a control terminal, wherein the first terminal of the first controllable switch is coupled to the power supply capacitor and the second terminal of the first controllable switch is coupled to the first voltage output circuit to receive the first voltage;
a first voltage limiting circuit configured to receive the second voltage, and to provide a first control voltage to the control terminal of the first controllable switch based on the second voltage;
a second controllable switch having a first terminal, a second terminal and a control terminal, wherein the first terminal of the second controllable switch is coupled to the power supply capacitor and the second terminal of the second controllable switch is coupled to the second voltage output circuit to receive the second voltage; and
a second voltage limiting circuit configured to receive the first voltage, and to provide a second control voltage to the control terminal of the second controllable switch based on the first voltage.

8. The power supply control circuit of claim 7, wherein:
when the first voltage provided by the first voltage output circuit is greater than a first limiting voltage, the second control voltage is equal to the first limiting voltage, and when the first voltage provided by the first voltage output circuit is less than the first limiting voltage, the second control voltage is equal to the first voltage; and
when the second voltage provided by the second voltage output circuit is greater than a second limiting voltage, the first control voltage is equal to the second limiting voltage, and when the second voltage provided by the second voltage output circuit is less than the second limiting voltage, the first control voltage is equal to the second voltage, wherein the first limiting voltage is less than the second limiting voltage.

9. The power supply control circuit of claim 7, wherein the first voltage limiting circuit comprises:
a first zener diode coupled between the primary ground and the control terminal of the first controllable switch; and
a first protection resistor coupled between an output terminal of the second voltage output circuit and the control terminal of the first controllable switch.

10. The power supply control circuit of claim 7, wherein the second voltage limiting circuit comprises:
a second zener diode coupled between the primary ground and the control terminal of the second controllable switch; and
a second protection resistor coupled between an output terminal of the first voltage output circuit and the control terminal of the second controllable switch.

11. The power supply control circuit of claim 7, wherein the power supply output circuit further comprises:
a first output diode coupled between the first terminal of the first controllable switch and the power supply capacitor; and
a second output diode coupled between the first terminal of the second controllable switch and the power supply capacitor.

12. The power supply control circuit of claim 7, wherein the second voltage limiting circuit further comprises:
an additional voltage output circuit coupled to the control terminal of the second controllable switch and configured to provide an additional voltage, wherein the additional voltage is less than the first limiting voltage and the second limiting voltage.

13. An isolated switching circuit, comprising:
a transformer having a primary winding, a secondary winding, a first auxiliary winding and a second auxiliary winding;
a first primary switch coupled between an input terminal of the isolated switching circuit and a switching terminal;
a second primary switch coupled between the switching terminal and a primary ground;
a resonant capacitor coupled in series with the primary winding;
a switching control circuit configured to control the first primary switch and the second primary switch; and
a power supply control circuit configured to provide a power supply voltage to the switching control circuit, wherein the power supply control circuit comprises:
a first voltage output circuit configured to receive a first auxiliary winding voltage from the first auxiliary winding, and to provide a first voltage indicating an input voltage of the isolated switching circuit based on the first auxiliary winding voltage;
a second voltage output circuit configured to receive a second auxiliary winding voltage from the second auxiliary winding, and to provide a second voltage indicating an output voltage of the isolated switching circuit based on the second auxiliary winding voltage; and
a power supply voltage output circuit coupled to the first voltage output circuit and the second voltage output circuit, wherein the power supply voltage output circuit is configured to provide the power supply voltage based on the first voltage and the second voltage.

14. The isolated switching circuit of claim 13, wherein the first voltage output circuit comprises:
a first auxiliary winding capacitor having a first terminal and a second terminal, wherein the first terminal of the first auxiliary winding capacitor is coupled to the first auxiliary winding;
a first switch coupled between the second terminal of the first auxiliary winding capacitor and an output terminal of the first voltage output circuit;
a second switch coupled between the primary ground and the second terminal of the first auxiliary winding capacitor; and
a first capacitor coupled between the output terminal of the first voltage output circuit and the primary ground.

15. The isolated switching circuit of claim 13, wherein the second voltage output circuit comprises:
a third switch coupled between the second auxiliary winding and an output terminal of the second voltage output circuit; and
a second capacitor coupled between the output terminal of the second voltage output circuit and the primary ground.

16. The isolated switching circuit of claim 13, wherein the power supply voltage output circuit comprises:
a power supply capacitor coupled between an output terminal of the power supply voltage output circuit and the primary ground;
a first controllable switch having a first terminal, a second terminal and a control terminal, wherein the first terminal of the first controllable switch is coupled to the power supply capacitor and the second terminal of the first controllable switch is coupled to the first voltage output circuit to receive the first voltage;
a first voltage limiting circuit configured to receive the second voltage, and to provide a first control voltage to the control terminal of the first controllable switch based on the second voltage;
a second controllable switch having a first terminal, a second terminal and a control terminal, wherein the first terminal of the second controllable switch is coupled to the power supply capacitor and the second terminal of the second controllable switch is coupled to the second voltage output circuit to receive the second voltage; and
a second voltage limiting circuit configured to receive the first voltage, and to provide a second control voltage to the control terminal of the second controllable switch based on the first voltage; wherein
when the first voltage provided by the first voltage output circuit is greater than a first limiting voltage, the second control voltage is equal to the first limiting voltage, and when the first voltage provided by the first voltage output circuit is less than the first limiting voltage, the second control voltage is equal to the first voltage; and
when the second voltage provided by the second voltage output circuit is greater than a second limiting voltage, the first control voltage is equal to the second limiting voltage, and when the second voltage provided by the second voltage output circuit is less than the second limiting voltage, the first control voltage is equal to the second voltage, wherein the first limiting voltage is less than the second limiting voltage.

17. The isolated switching circuit of claim 13, wherein the first voltage limiting circuit comprises:
a first zener diode coupled between the primary ground and the control terminal of the first controllable switch; and
a first protection resistor coupled between an output terminal of the second voltage output circuit and the control terminal of the first controllable switch.

18. The isolated switching circuit of claim 13, wherein the second voltage limiting circuit comprises:
a second zener diode coupled between the primary ground and the control terminal of the second controllable switch; and
a second protection resistor coupled between an output terminal of the first voltage output circuit and the control terminal of the second controllable switch.

19. A method for providing a power supply voltage for an isolated switching circuit, wherein the isolated switching circuit has a primary circuit, a secondary circuit and a transformer having a primary winding, a secondary winding, a first auxiliary winding and a second auxiliary winding, the method comprising:
receiving a first auxiliary winding voltage from the first auxiliary winding, and providing a first voltage indicating an input voltage of the isolated switching circuit based on the first auxiliary winding voltage;
receiving a second auxiliary winding voltage from the second auxiliary winding, and providing a second voltage indicating an output voltage of the isolated switching circuit based on the second auxiliary winding voltage; and
providing the power supply voltage based on the first voltage and the second voltage.

20. The method of claim 19, wherein the step of providing the power supply voltage based on the first voltage and the second voltage comprises:
receiving the second voltage and providing a first control voltage based on the second voltage;
receiving the first voltage and providing a second control voltage based on the first voltage; and
providing the power supply voltage based on the first voltage, the first control voltage, the second voltage and the second control voltage; wherein
when the first voltage is greater than a first limiting voltage, the second control voltage is equal to the first limiting voltage, when the first voltage is less than the first limiting voltage, the second control voltage is equal to the first voltage; and
when the second voltage is greater than a second limiting voltage, the first control voltage is equal to the second limiting voltage, when the second voltage is less than the second limiting voltage, the first control voltage is equal to the second voltage, wherein the first limiting voltage is less than the second limiting voltage.
